(19) United States
(12) Patent Application Publication
(10) Pub. No.: US 2011/0250350 A1
(43) Pub. Date: Oct. 13, 2011

(54) NOVEL TIE-COAT COMPOSITIONS

(75) Inventors: Peter Christian Weinrich Thorlaksen, Solrod Strand (DK); Anders Blom, Espergaerde (DK)

(73) Assignee: Hempel A/S, Lyngby (DK)

(21) Appl. No.: 13/058,527

(22) PCT Filed: Aug. 11, 2009
(86) PCT No.: PCT/EP09/60373

§ 371 Date: May 19, 2011

(30) Foreign Application Priority Data
Aug. 11, 2008 (EP) 08162164.1

(51) Int. Cl. B05D 3/10; B05D 1/36; C09D 5/16

(52) U.S. Cl. 427/140; 524/588; 427/407.1

(57) ABSTRACT

The present application discloses a condensation cure silicone RTV tie-coat composition comprising (i) a silanol-terminated polydiorganosiloxane, and (ii) 0.1-10% by wet weight of the total tie-coat composition of one or more adhesion promoters selected from the group consisting of bis(trialkoxysilylalkyl)amines and N,N′-bis(trialkoxysilylalkyl)alkylenediamines and optionally (iii) up to 30% by wet weight of the total tie-coat composition of one or more hydrolysable silanes. Further are disclosed a method of restoring a damaged foul release coating system area on a substrate and a method of applying a foul release coating system to a freshly applied substrate of anticorrosive coat, utilizing tie-coat composition.

### FIELD OF THE INVENTION

The present invention relates to silicone based tie-coat compositions for fouling-release paint systems. The invention provides a method of coating a substrate with a polysiloxane-based tie-coat composition comprising an adhesion promoter that in most situations would render the use of a curing catalyst unnecessary. The silicone based coating composition can be used either as a repair and maintenance tie-coat for damaged silicone areas or as a tie-coat for new applications. The present invention also provides a composition particularly useful for said methods.

### BACKGROUND OF THE INVENTION

Aquatic structures, in particular immersed marine structures that come in contact with water, especially sea water, have a tendency to become fouled by marine organisms. Fouling release paint systems are abundantly used for such structures, e.g. ships, buoys, watercraft structures, etc., in order to suppress settlement of such marine organisms. While silicones are recognized as effective anti-fouling coatings when in contact with sea water, silicones do not possess the anti-corrosion resistance of various organic materials, such as epoxy resins. As a result, standard fouling release systems for steel structures typically include three principal layers, namely an epoxy-based anticorrosive layer applied to the steel substrate, a fouling-release layer which typically comprises a polysiloxane-based matrix, and an intermediate layer, often referred to as a “tie-coat”, for establishing strong bonding between the otherwise incompatible epoxy-based anticorrosive layer and the polysiloxane-based fouling release layer.

One of the major challenges involved with fouling release systems is the occasional need to repair. Experience has shown that while adhesion is generally satisfactory between the anticorrosive epoxy coating and the silicone based tie-coat, and between the silicone based tie-coat and the fouling release top-coat, adhesion between the fouling release top-coat and the anticorrosive epoxy coat is inferior.

As a result, if a ship suffers peripheral damage to its hull, even in a limited area, which can result in the penetration or destruction of one or more of the silicone-epoxy coating layers, a complicated repair procedure is often necessary. For example, restoration of the silicone-epoxy coating layers may require the re-application of the original anti-corrosive epoxy coating onto freshly sanded steel surface, followed by treating the epoxy layer with a tie-coat, finalised with the application of the silicone foul release top-coat.

It would therefore be desirable to provide a simpler patching or repair process to allow the direct application of the silicone foul release system onto the damaged area of the ship's hull in an effective manner.

U.S. Pat. No. 6,013,754 discloses a catalyst-free polydiorganosiloxane-based primer composition. In some examples, the composition comprises—as adhesion promoters—an amino silane, e.g. N-(2-aminoethyl)-3-aminopropyltrimethoxysilane, in combination with an organomodified siloxane. The organomodified siloxane appears to be disadvantageous with respect to stability insofar the composition is to be use on top of aged epoxy coatings.

EP 1013347 B1 (General Electric Co.) discloses a method of restoring damaged foul release coating area on metallic substrate by applying a two-part condensation cure silicone RTV adhesion promoting layer on to the damaged area. The adhesion promoting layer comprises a silanol-terminated polydiorganosiloxane and about 0.5 to 5.5% based on the weight of the silanol-terminated polydiorganosiloxane of an aminoalkyltrialkoxysilane. While the amino-alkyltrialkoxysilane used in the practice of the invention is preferably γ-aminopropyltri-methoxysilane, other aminoalkyltrialkoxysilanes can be used such as NH₂RSi(OR¹)₃ where R is methylene, dimethylene, or C(4-8) alkylene, and R¹ is C(1-8) alkyl. In the preferred embodiment of the coating composition, the composition further comprises a tin oxide curing catalyst component.

In view of the above, there is still a need for improved tie-coat compositions for fouling-release coating systems. It has now surprisingly been discovered that the use of a specific type of adhesion promoter provides advantages over the compositions disclosed in EP 1013347 B1, e.g. by—in most cases—rendering a curing catalyst unnecessary.

### SUMMARY OF THE INVENTION

In one aspect, the present invention relates to a tie-coat composition, cf. claim 1.

In another aspect, the present invention relates to a method of restoring a damaged foul release coating system area on a substrate, cf. claim 10.

In yet another aspect, the present invention relates to a method of applying a foul release coating system to a freshly applied substrate of anticorrosive coat, cf. claim 11.

In yet another aspect, the present invention relates to a substrate comprising on at least a part of the surface thereof a tie-coat prepared by application of tie-coat composition as defined herein, cf. claim 12.

### DETAILED DESCRIPTION OF THE INVENTION

The present invention provides an improved method and an advantageous tie-coat composition particularly useful in connection with fouling-release coating systems.

The coating of the present invention is a condensation cure silicone RTV tie-coat composition comprising

(i) a silanol-terminated polydiorganosiloxane, preferably a silanol-terminated polydimethylsiloxane, in particular selected from those having a viscosity between 1,000 and 50,000 centipoise, and

(ii) 0.1-10% by wet weight of the total tie-coat composition of one or more adhesion promoters selected from the group consisting of bis(trialkoxysilylalkyl)amines and N,N′-bis(trialkoxysilylalkyl)alkylenediamines, in particular selected from the group consisting of bis(trialkoxysilylalkyl)amines.

In one interesting embodiment, the composition optionally comprises (iii) up to 30% by wet weight of the total tie-coat composition of one or more silanes having two or more hydrolysable groups (see further below).

### Polysiloxane Binder

Without being bound by any specific theory, it is believed that the silanol-terminated polydiorganosiloxane used in the present invention advantageously could be, but not limited to, a silanol-terminated polydimethylsiloxane. The silanol-terminated polydiorganosiloxane of the present invention should preferably have a viscosity between 1,000 and 50,000 centipoise.

The total amount of silanol-terminated polydiorganosiloxanes in the tie-coat composition is in the range of 10-90%, such as 20-80%, e.g. 25-75% by wet weight of the total tie-coat composition. In one particularly interesting embodiment, the total amount is in the range of 30-60% by wet weight of the tie-coat composition.

Mixtures of two or more silanol-terminated polydiorganosiloxanes may be used if desired.

Examples of suitable silanol-terminated polydiorganosiloxanes are:

RF-5000, ex. Shin-Etsu—Japan, silanol-terminated polydimethylsiloxane, viscosity 5,000 centipoise

Rhodorsil Oil 48V5000, ex. Bluestar Silicones—France, silanol-terminated polydimethylsiloxane, viscosity 5,000 centipoise

### Adhesion Promotor

The use of one or more bis(trialkoxysilylalkyl)amines and/or N,N′-bis(trialkoxysilylalkyl)-alkylenediamines as adhesion promoter(s) is believed to give significant improvement in adhesion properties without the use of a curing catalyst. Especially the use of one or more bis(trialkoxysilylalkyl)amines gives significant improvement in adhesion properties without the use of a curing catalyst. Apart from the improved adhesion properties, it is further believed, that the use of the specific adhesion promoter type results in more flexible over coating intervals, both for the tie-coat applied on epoxy substrates, and for the foul release top-coat applied on the tie-coat.

In some embodiments, the composition further includes a curing catalyst. In other embodiments, the composition is devoid of any metal curing catalyst, in particular devoid of any curing catalyst. Hence, in many embodiments, the use of curing catalyst, especially metal catalysts such as tin catalyst, is preferably avoided, as some of these catalysts appear to be environmentally disfavoured.

It is also believed that the specific type of adhesion promoter supplies the tie-coat composition with more tolerance towards the substrate to be applied, e.g. it is believed that the tie-coat can adhere both to old and freshly applied epoxy and silicone substrates.

It is also believed that the specific type of adhesion promoter supplies the tie-coat with curing properties sufficient for most application conditions without the use of a curing catalyst. Furthermore it is believed, that the use of the specific adhesion promoter type without the need to add curing catalyst, provides the means for achieving a longer pot life (work time after the product is mixed) compared to compositions comprising a catalyst.

It is believed that the specific type of adhesion promoter in general supplies the tie-coat with advantages compared to known technology. E.g. a relative long pot-life combined with a relative fast drying in a wide temperature and humidity range on a variety of substrates.

Preferred bis(trialkoxysilylalkyl)amines are bis(trialkoxysilylalkyl)amines having formula (I):

Si(OR³)₃R¹NHR²Si(OR⁴)₃ (I)

where R¹ and R² independently are C1-C5 alkylene groups and R³ and R⁴ independently are selected from methyl and ethyl.

Preferred N,N′-bis(trialkoxysilylalkyl)alkylenediamines are N,N′-bis(trialkoxysilylalkyl)alkylenediamines having formula (II):

Si(OR³)₃R¹NHR⁵NHR²Si(OR⁴)₃ (II)

where R¹, R² and R⁵ independently are C1-C5 alkylene groups and R³ and R⁴ independently are selected from methyl and ethyl.

The term “C1-C5 alkylene groups” refers to straight chain, branched or cyclic groups of the formula -C1-C5-alkylene-, e.g. methylene, 1,2-ethylene, 1,1-ethylene, 1,3-propylene, 1,2-propylene, 2,2-propylene, etc.

In particular, R¹ and R² in formula (I) and (II) are preferably 1,3-propylene, and R⁵ in formula (II) is preferably ethylene.

Bis(trialkoxysilylalkyl)amines are especially preferred as adhesion promoter(s)

Mixtures of two or more adhesion promoters may be used if desired.

Examples of suitable adhesion promotors are:

Dynasylan 1124, ex. Evonik Degussa GmbH—Germany, bis(3-trimethoxysilylpropyl)amine.

Silquest A-1170, ex. Momentive Performance Materials GmbH—Germany, bis(3-trimethoxysilylpropyl)amine.

SIB1824.5, ex. Gelest Inc.—USA, bis(3-triethoxysilylpropyl)amine.

SIB1834.1, ex. Gelest Inc.—USA, bis[(3-trimethoxysilyl)propyl]ethylenediamine.

Among these, bis(3-trimethoxysilylpropyl)amine and bis(3-triethoxysilylpropyl)amine, in particular bis(3-trimethoxysilylpropyl)amine, e.g. Dynasylan 1124 or Silquest A-1170, are the currently most preferred.

The total amount of adhesion promoter in the tie-coat composition is in the range of 0.1-10%, such as 0.15-7% or 0.3-8%, e.g. 0.2-5% or 0.5-6%, by wet weight of the total tie-coat composition. In one particularly interesting embodiment, the total amount is in the range of 1-5% by wet weight of the tie-coat composition. In another particularly interesting embodiment, the total amount is in the range of 0.2-4% by wet weight of the tie-coat composition. Mixtures of two or more of the mentioned adhesion promoters may be used if desired.

### Hydrolysable Silanes

In order to increase the crosslink density and adhesion properties of the tie-coat, additional one or more silanes having two or more hydrolysable groups may be added to the composition.

Hence, in one embodiment, the composition further comprises (iii) up to 30% by wet weight of the total tie-coat composition of one or more silanes having two or more hydrolysable groups.

By the term “silane having two or more hydrolysable groups” (or, in short, “hydrolysable silane”) is meant a compound comprising a Si—O—X group which is hydrolysable.

Illustrative examples hereof are compounds comprising a moiety of the type:

R¹—Si(R²)(R³)—

wherein two or three, preferably three, of R¹, R², and R³ are independently a hydrolysable group selected from oximino (e.g. a methylethylketoximo group), acetoxy and alkoxy, and any remaining of R¹, R² and R³ is a non-hydrolysable group selected from C1-C12 alkyl (e.g. methyl and ethyl), (meth)acryloxymethyl, C2-C6 alkenyl (e.g. vinyl) and phenyl. Preferred examples of hydrolysable groups attached directly to the silicon atom are alkoxy groups (such as methoxy, propoxy, isopropoxy, butoxy and isobutoxy), oxime groups, and acetoxy groups.

The term “C1-C12 alkyl” refers to straight chain, branched or cyclic hydrocarbon groups, e.g. methyl, ethyl, 1-propyl, 2-propyl, 1-octyl, etc.

The term “C2-C6 alkenyl” refers to straight chain, branched or cyclic hydrocarbon groups having one double bond, e.g. vinyl, cyclohexene, etc.

Such hydrolysable silanes (including oligomers thereof) typically have a total of 1-5 silicon atoms, such as 1-3 silicon atoms, in particular one silicon atom.

Preferred hydrolysable groups are alkoxy and oximo groups.

A preferred group of hydrolysable silanes is represented by the formula

R¹—Si(R²)(R³)—R⁴

wherein two or three or four, preferably three, of R¹, R², R³ and R⁴ are independently a hydrolysable group selected from oximino (e.g. a methylethylketoximo group), acetoxy and alkoxy, and any remaining of R¹, R², R³ and R⁴ is a non-hydrolysable group selected from C1-C12 alkyl (e.g. methyl and ethyl), (meth)acryloxymethyl, C2-C6 alkenyl (e.g. vinyl) and phenyl.

When present, the total amount of (iii) additional silane having hydrolysable groups in the tie-coat composition is up to 30%, such as in the range of 1-20%, e.g. 2-10%, by wet weight of the total tie-coat composition. In one particularly interesting embodiment, the total amount is in the range of 3-9% by wet weight of the total tie-coat composition. Mixtures of two or more hydrolysable silanes may be use if desired.

Examples of commercially available suitable hydrolysable silanes are:

Alkoxy silanes such as:

Dynasylan VTEO, ex. Evonik Degussa GmbH—Germany, vinyltriethoxysilane.

Dynasylan VTMO, ex Evonik Degussa GmbH—Germany, vinyltrimethoxysilane.

Dynasylan 6498, ex. Evonik Degussa GmbH—Germany, oligomeric vinyltriethoxysilane.

Silquest A-link 597, ex. Momentive Performance Materials GmbH—Germany, tris(3-(trimethoxysilyl)propyl)isocyanurate.

Dynasylan 6598, ex. Evonik Degussa GmbH—Germany, Vinyl-alkyl siloxane oligomer.

Dynasylan OCTEO, ex. Evonik Degussa GmbH—Germany, octyltriethoxysilane.

Dynasylan PTEO, ex. Evonik Degussa GmbH—Germany, propyltriethoxysilane.

Dynasylan MTMS, ex. Evonik Degussa GmbH—Germany, methyltrimethoxysilane.

Dynasylan P, ex. Evonik Degussa GmbH—Germany, tetra-n-propylsilicate.

Dynasylan 9165, ex. Evonik Degussa GmbH—Germany, phenyltrimethoxysilane.

Dynasylan A, ex. Evonik Degussa GmbH—Germany, tetraethoxysilane.

Silikat TES 40 WN, Wacker Chemie AG—Germany, ethyl silicate.

Silres SY 231, ex. Wacker Chemie AG—Germany, alkoxy functional polysiloxane.

Geniosil XL32, ex. Wacker Chemie AG—Germany, (methacryloxymethyl)-methyldimethoxysilane.

Geniosil XL33, ex. Wacker Chemie AG—Germany, methacryloxymethyltrimethoxysilane.

Geniosil XL34, ex. Wacker Chemie AG—Germany, (methacryloxynnethyl)-methyldiethoxysilane.

Geniosil XL36, ex. Wacker Chemie AG—Germany, methacryloxymethyltriethoxysilane.

Dynasylan GLYMO, ex. Evonik Degussa GmbH—Germany, gamma glycidoxypropyl trimethoxysilane.

Silanes with oxime or acetoxy functionalities such as:

SIV9280.0, ex. Gelest, Inc.—USA, vinyltris(methylethylketoximo)silane.

SIM6590.0, ex. Gelest, Inc.—USA, methyltris(methylethylketoximo)silane.

SIM6519.0, ex. Gelest, Inc.—USA, methyltriacetoxysilane.

SIM9098.0, ex. Gelest, Inc.—USA, vinyltriacetoxysilane.

Preferred example of hydrolysable silanes are methyl trimethoxy silane, vinyl trimethoxy silane, vinyltris(methylethylketoximo)silane, methyltris(methylethylketoximo)silane, methyltriacetoxysilane and bis(3-trimethoxysilylpropyl)amine.

In one embodiment hereof, the system is a one part system comprising (i) the silanol-terminated polydiorganosiloxane, (ii) the one or more adhesion promoters, and optionally (iii) the one or more hydrolysable silanes.

In most variants within this interesting embodiment, it is believe that (i) the silanol-terminated polydiorganosiloxane and (iii) the hydrolysable silane(s) will—at least in part—be mutually reactive and will (again at least in part) form species where the silanol-terminal groups of the silanol-terminated polydiorganosiloxane are replace by reactive groups, e.g. alkoxy groups, oxime groups or acetoxy groups. This (pre)reaction will render the polydiorganosiloxane binder moisture curable. Hence, in this manner a one component RN composition is obtained.

It if further envisaged that it may be beneficial to allow (i) the silanol-terminated polydiorganosiloxane and (iii) the hydrolysable silane(s) to pre-react before admixture with (ii) the one or more adhesion promoters and any other constituents of the composition. It is even envisaged that available products (such as commercial products) corresponding to those obtained (or obtainable) by reaction of (i) the silanol-terminated polydiorganosiloxane and (iii) the hydrolysable silane(s) may in full or in part substitute (i) the silanol-terminated polydiorganosiloxane and (iii) the hydrolysable silane(s) in the composition.

The molar ratio between hydrolysable groups in (iii) and silanol groups in (i) should be at least 3:1, preferably 15:1 and more preferably 20:1.

In some variants of the above, the tie-coat composition further comprises (iv) an epoxy silane in a part separate from the part comprising (ii) the one or more adhesion promoters.

In a further variant of the above, the system is a two part system where the first component (part) comprises (i) the silanol-terminated polydiorganosiloxane, (ii) the one or more adhesion promoters, and optionally (iii) the one or more hydrolysable silanes, and where the second component (part) comprises (iv) an epoxy silane. An epoxy silane can generally be described as an organosilane with both hydrolysable groups and epoxy functionality. Examples of epoxy silanes are gamma glycidoxypropyl trimethoxysilane, gamma glycidoxypropyl triethoxysilane, beta-(3,4-epoxycyclohexyl)-ethyl trimethoxysilane, beta-(3,4-epoxycyclohexyl)-ethyl triethoxysilane, and oligomers hereof.

In a still further variant, the system is a two part system where the first component (part) comprises (i) the silanol-terminated polydiorganosiloxane, optionally (iii) the one or more hydrolysable silanes and (iv) an epoxy silane (such as gamma glycidoxypropyl trimethoxysilane, gamma glycidoxypropyl triethoxysilane, beta-(3,4-epoxycyclohexyl)-ethyl trimethoxysilane, beta-(3,4-epoxycyclohexyl)-ethyl triethoxysilane or oligomers hereof), and the second component (part) comprises (ii) the one or more adhesion promoters.

In some other embodiments, the composition is a two part system wherein the silanol-terminated polydiorganosiloxane (i) is included in the one part, and wherein the one or more adhesion promoters (ii) are included in the second part.

In still another embodiment, additional alkoxy silane can be added to part (ii), in particular when the composition is a two part system.

The total amount in this embodiment of additional alkoxy silane (or organofunctional silane, i.e. alkoxy silane carrying a further functional group, e.g. (meth)acryloxymethyl groups, such as in (methacryloxymethyl)-methyldimethoxysilane, methacryloxymethyltrimethoxysilane, (methacryloxymethyl)-methyldiethoxysilane, methacryloxymethyltriethoxysilane, etc.) in the tie-coat composition is in the range of 0-10%, such as 0.1-8%, e.g. 0.3-6% by wet weight of the total tie-coat composition. In one particularly interesting embodiment, the total amount is in the range of 0.5-5% by wet weight of the total tie-coat composition.

Mixtures of two or more alkOxy silanes or organofunctional silanes may be used if desired.

In one preferred embodiment the tie-coat composition comprises 0-10%, such as 0.1-8%, e.g. 0.3-6% by wet weight of the total tie-coat composition of an alkoxy silane or oligomer thereof selected from the group consisting of vinyltrialkoxysilanes, vinyltrialkoxysilane oligomers, tris(3-(trialkoxysilyl)alkyl)isocyanurate, vinyl-alkyl siloxane oligomer, alkyl trialkoxy silane, phenyl trialkoxy silanes, tetraalkoxy silanes and alkyl silicates.

As above, the above two part system may also be made as a one part system. Part (ii) and optionally one or more of the alkoxy silanes described above are mixed into one component by using a moisture curable binder as replacement for part (i) consisting of polydiorgano-siloxane (preferably polydimethylsiloxane) with hydrolysable end-capping, which can be, but is not limited to oxime, acetoxy, methoxy, propoxy, isopropoxy, butoxy and isobutoxy.

In some embodiments, it is advantageous no to include any tetraalkoxy silanes (tetraalkyl silicates) such as tetraethoxy silane (tetraethyl silicate).

### Other Constituents

Without being bound by any specific theory, it is also believed that although good results generally can be achieved with the catalyst free compositions of the present invention, the use of a curing catalyst could in some specific situations provide additional curing performance. For instances, it is believed that the use of a curing catalyst in the compositions of the present invention would be beneficial e.g. for very low temperature and/or very low humidity curing. If needed, the compositions of the present invention can therefore be added a curing catalyst such as a metallic salt of a carboxylic or organocarboxylic acid, organotitanic acid esters, organotitanium compounds, alkoxy-aluminium compounds, amine compounds and salts therefore, quaternary ammonium salt, alkali metal salts of lower fatty acids, titanates, zirconates, and iron salts of fatty acids, dialkylhydroxylamines, and guanidine compounds and guanidyl group-containing silanes or siloxanes.

The coating composition may further, as a part of the binder phase, comprise solvents and additives.

Examples of solvents are aliphatic, cycloaliphatic and aromatic hydrocarbons such as white spirit, cyclohexane, toluene, xylene and naphtha solventesters such as methoxypropyl acetate, n-butyl acetate and 2-ethoxyethyl acetate; and mixtures thereof. Volatile methyl siloxanes such as octamethyltrisiloxane or hexamethyldisiloxane can also be used.

Examples of additives are:

(i) surfactants such as derivatives of propylene oxide or ethylene oxide such as alkylphenol-ethylene oxide condensates; ethoxylated monoethanolamides of unsaturated fatty acids such as ethoxylated monoethanolamides of linoleic acid; sodium dodecyl sulfate; alkylphenol ethoxylates; and soya lecithin;

(ii) wetting agents and dispersants such as those described in M. Ash and I. Ash, “Handbook of Paint and Coating Raw Materials, Vol. 1”, 1996, Gower Publ. Ltd., Great Britain, pp 821-823 and 849-851;

(iii) stabilisers against moisture such as molecular sieves or water scavengers such as synthetic zeolites, substituted isocyanates, substituted silanes and ortho formic acid triethyl ester; stabilisers against oxidation such as butylated hydroxyanisole; butylated hydroxytoluene; propylgallate; tocopherols; 2,5-di-tert-butyl-hydroquinone; L-ascorbyl palmitate; carotenes; vitamin A;

(v) thickeners and anti-settling agents such as colloidal silica, hydrated aluminium silicate (bentonite), aluminiumtristearate, aluminiummonostearate, xanthan gum, chrysotile, pyrogenic silica, hydrogenated castor oil, organo-modified clays, polyamide waxes and polyethylene waxes;

(vi) dyes such as 1,4-bis(butylamino)anthraquinone and other anthraquinone derivatives; toluidine dyes, etc.

Furthermore, the coating composition may comprise pigments and fillers.

Examples of pigments are grades of titanium dioxide, red iron oxide, zinc oxide, carbon black, graphite, yellow iron oxide, red molybdate, yellow molybdate, zinc sulfide, antimony oxide, sodium aluminium sulfosilicates, quinacridones, phthalocyanine blue, phthalocyanine green, black iron oxide, indanthrone blue, cobalt aluminium oxide, carbazole dioxazine, chromium oxide, isoindoline orange, bis-acetoacet-o-tolidiole, benzimidazolon, quinaphtalone yellow, isoindoline yellow, tetrachloroisoindolinone, and quinophthalone yellow.

Examples of fillers are calcium carbonate such as calcite, dolomite, talc, mica, feldspar, barium sulfate, kaolin, nephelin, silica, perlite, magnesium oxide, and quartz flour, etc. Fillers (and pigments) may also be added in the form of fibres, thus, apart from the before-mentioned examples of fillers, the coating composition may also comprise fibres, e.g. those generally and specifically described in WO 00/77102 which is hereby incorporated by reference.

In some embodiments, it is advantageous not to include silica (e.g. fumed silica).

The coating compositions may be prepared by conventional method using equipment known to the person skilled in the art, e.g. utilising mixers, ball mills, dymo mill, grinders, filters, etc. The coating compositions are typically prepared and shipped as one- or two-component systems that should be combined and thoroughly mixed immediately prior to use. An example of a suitable preparation method is described in the “Examples” section.

### Preferred Embodiment

In one preferred embodiment the tie-coat comprises:

(i) 30-60% by wet weight of the total tie-coat composition of a silanol-terminated polydiorganosiloxane, and

(ii) 1-5%, or 0.2-4%, by wet weight of the total tie-coat composition of one or more adhesion promoters selected from the group consisting of bis(trialkoxysilylalkyl)amines and N,N′-bis(trialkoxysilylalkyl)alkylenediamines, and

(iii) 0-5%, or 3-9%, by wet weight of the total tie-coat composition of one or more hydrolysable silanes.

In a further preferred embodiment the tie-coat comprises:

(i) 30-60% by wet weight of the total tie-coat composition of a silanol-terminated polydiorganosiloxane, and

(ii) 1-5%, or 0.2-4%, by wet weight of the total tie-coat composition of one or more adhesion promoters selected from the group consisting of bis(trialkoxysilylalkyl)amines,

(iii) 0-5%, or 3-9%, by wet weight of the total tie-coat composition of one or more hydrolysable silanes;

e.g.

(i) 30-60% by wet weight of the total tie-coat composition of a silanol-terminated polydiorganosiloxane, and

(ii) 1-5%, or 0.2-4%, by wet weight of the total tie-coat composition of bis(3-trimethoxysilylpropyl)amine,

(iii) 0-5%, or 3-9%, by wet weight of the total tie-coat composition of one or more hydrolysable silanes.

In a still further preferred embodiment the tie-coat comprises:

(i) 30-60% by wet weight of the total tie-coat composition of a oxime terminated moisture curable polydiorganosiloxane, and

(ii) 0.1-4% by wet weight of the total tie-coat composition of one or more adhesion promoters selected from the group consisting of bis(trialkoxysilylalkyl)amines and N,N′-bis(trialkoxysilylalkyl)alkylenediamines, and

(iii) 0-5% by wet weight of the total tie-coat composition of one or more alkoxy silane,

(iv) 0-3% by wet weight of the total tie-coat composition of one or more epoxy silanes.

In a still further embodiment the tie-coat composition comprises in one part:

(i) a silanol-terminated polydiorganosiloxane,

(ii) 0.1-10% by wet weight of the total tie-coat composition of one or more adhesion promoters selected from the group consisting of bis(trialkoxysilylalkyl)amines and N,N′-bis(trialkoxysilylalkyl)alkylenediamines; and

(iii) up to 30% by wet weight of the total tie-coat composition of one or more silanes having two or more hydrolysable groups.

In a still further embodiment, the tie-coat composition comprises

(i) a silanol-terminated polydiorganosiloxane in a first part, and

(ii) 0.1-10% by wet weight of the total tie-coat composition of one or more adhesion promoters selected from the group consisting of bis(trialkoxysilylalkyl)amines and N,N′-bis(trialkoxysilylalkyl)alkylenediamines in a second part.

### Method of Coating a Substrate

In one aspect, the present invention provides a method of coating a substrate, the method comprising:

(i) applying a condensation cure silicone RTV tie-coat to at least a part of the surface of said substrate thereby establishing a condensation cure silicone RIV tie-coat on said substrate, wherein said coating composition comprises 0-60%, such as 0-50%, preferably 5-45%, such as 5-35%, by wet weight of pigments and fillers; and the balance of a binder phase (i.e. the coating composition devoid of any pigments and fillers) comprising: 10-90% by wet weight of the total tie-coat composition of a silanol-terminated polydiorganosiloxane, 0.1-10% by wet weight of the total tie-coat composition of an adhesion promotor, and optionally up to 30% by wet weight of the total tie-coat composition of hydrolysable silanes(s) (e.g. additional alkoxy silane or organofunctional silanes).

The term “binder phase” of the condensation cure silicone RN tie-coat composition means the sum of the constituents of the condensation cure silicone RN tie-coat composition not being pigments and/or fillers. Typically, the binder phase of the composition constitutes 40-100%, such as 45-100%, e.g. 50-95%, such as 55-95%, by wet weight of the total tie-coat composition. On the other hand, the condensation cure silicone RTV tie-coat composition typically comprises 0-60%, such as 0-55%, preferably 5-50 such as 5-45%, by wet weight of the total tie-coat composition of pigments and fillers.

In some embodiments of the method, the composition is a two part system, and in other embodiments, the composition is a one part system. These embodiments will be apparent from the description of the compositions.

The term “% by wet weight” means the percentage of the respective constituent(s) based on the composition including any solvents.

The term “substrate” is intended to mean a solid material onto which the tie-coat composition is applied. The substrate typically comprises a metal such as steel, iron, aluminum, or a glass-fibre material. In the most interesting embodiments, the substrate comprises a metal, in particular steel or aluminum.

The term “surface” is used in its normal sense, and refers to the exterior boundary of an object. Particular examples of such surfaces are the surface of vessels (including but not limited to boats, yachts, motorboats, motor launches, ocean liners, tugboats, tankers, container ships and other cargo ships, submarines, and naval vessels of all types), pipes, shore and off-shore machinery, constructions and objects of all types such as piers, pilings, bridge substructures, water-power installations and structures, underwater oil well structures, nets and other aquatic culture installations, and buoys, etc.

The surface of the substrate may either be the “native” surface, or the substrate may carry any paint coat, e.g. an anticorrosive coat, a tie-coat, a foul release top-coat. The coats that constitutes the substrate may either be freshly applied coats or aged or worn-out coats.

As described above, the tie coat composition can be used as a repair coat for restoring a damaged foul release coat system. The tie coat composition as such is somewhat surface tolerant and can in most situations be applied directly on to the surface in question. However, in some cases, it may be necessary to clean the substrate to acceptable application conditions before application of the tie coat composition, e.g. it may be necessary to remove fouling by means of high pressure fresh water jetting, or to remove rust by sand or swirp blasting.

“Freshly applied coats” are defined as coats which have been applied within days before the specific time in question. “Aged coats” are defined as coats which have been applied within months or years before the specific time in question. “Worn-out coats” is defined as any type of coat where the coat has completely or almost completely lost its original function.

In one important embodiment, the substrate is a metal substrate (e.g. a steel substrate) coated with an anticorrosive coating such as an anticorrosive epoxy-based coating, e.g. cured epoxy-based coating.

In another important embodiment, the substrate is a metal substrate (e.g. a steel substrate) coated with an anticorrosive coating and subsequently coated with a silicone based tie-coat.

In yet another important embodiment, the substrate is a metal substrate (e.g. a steel substrate) coated with an anticorrosive coating, subsequently coated with a silicone based tie-coat, and subsequently coated with a silicone based foul release top-coat.

The term “applying” is used in its normal meaning within the paint industry. Thus, “applying” is conducted by means of any conventional means, e.g. by brush, by roller, by spraying, by dipping, etc. The commercially most interesting way of “applying” the condensation cure silicone RTV tie-coating composition is by spraying. Spraying is effected by means of conventional spraying equipment known to the person skilled in the art, including two-component spraying equipment. The condensation cure silicone RTV tie-coat is typically applied in a total dry film thickness of 20-900 μm, such as 20-750 μm, e.g. 50-600 μm, such as 50-300, in 1-3 layer(s).

The term “at least a part of the surface of said substrate” refers to the fact that the condensation cure silicone RTV tie-coat may be applied to any fraction of the surface. For many applications, the condensation cure silicone RN tie-coat is at least applied to the part of the substrate (e.g. a vessel) where the surface (e.g. the ship's hull), possibly after application of a fouling release layer, may come in contact with water, e.g. sea-water or fresh water.

In view of the above, the present invention also provides a substrate comprising on at least a part of the surface thereof a tie-coat prepared by application of tie-coat composition as defined hereinabove.

The present invention is further illustrated by the following non-limiting examples.

### EXAMPLES

### Materials

RF-5000, ex. Shin-Etsu—Japan, silanol-terminated polydimethylsiloxane

Dynasylan 1124, ex. Evonik Degussa GmbH—Germany, bis(3-trimethoxysilylpropyl)amine

SIB1824.5, ex. Gelest Inc.—USA, bis(3-triethoxysilylpropyl)amine

SIM6590.0, ex. Gelest, Inc.—USA, methyltris(methylethylketoximo)silane

SIV9280.0, ex. Gelest, Inc.—USA, vinyltris(methylethylketoximo)silaneDynasy/an Glymo, ex. Evonik Degussa GmbH—Germany, Gamma glycidoxypropyl trimethoxysilane

Mikhart 5, ex. Provencale SA—France, calcium carbonate

Tioxide TR81, ex. Huntsman—United Kingdom, titanium dioxide

Omnixon YE 6420, ex. Nordic Pigments—Denmark, iron oxide

Xylene from local supplier

Model paint composition C (comparative example) contains the adhesion promoter as described in the experimental part of EP 1013347 B1 (General Electric Co.) which is incorporated herein as reference.

The adhesion promoter used herein is a y-aminopropyltrimethoxysilane available from Evonik Degussa GmbH—Germany.

### Preparation Method for the Model Paints

Composition A, B and C:

Part (i) (silanol-terminated polydimethylsiloxane, iron oxide pigment, calcium carbonate, titanium dioxide, and xylene) was mixed on a Diaf dissolver equipped with an impeller disc (70 mm in diameter) in a 1 L can for 15 minutes at 2000 rpm.

Part (ii) (adhesion promoter, xylene, and additional hydrolysable silane (if present)) was mixed on a Diaf dissolver equipped with an impeller disc (70 mm in diameter) in a 1 L can for 2 minutes at 500 rpm. Part (ii) should preferably be mixed under nitrogen blanket as some of the components in part (ii) are sensitive to moisture.

Just before the application, part (i) and part (ii) was mixed to a homogenous mixture.

All entries in model paints table below are in weight unless otherwise stated.

| | | | Tie- |
|---|---|---|---|
| | | | coat |
| | | | compo- |
| | | | sition |
| | Tie- | Tie- | C |
| | coat | coat | (Compar- |
| | compo- | compo- | ative |
| | sition | sition | exam- |
| MODEL PAINTS | A | B | ple) |
| Part (i) | | | |
| Silanol-terminated | 50.0 | 50.0 | 50.0 |
| polydimethylsiloxane (5,000 | | | |
| centipoise) | | | |
| Xylene | 15.0 | 15.3 | 15.0 |
| Calcium carbonate | 20.0 | 17.1 | 20.0 |
| Titanium dioxide | 12.0 | 16.0 | 12.0 |
| Iron oxide | 3.0 | 3.0 | 3.0 |
| Total part (i) | 100.0 | 101.4 | 100 |
| Part (ii) | | | |
| Bis(3-trimethoxysilylpropyl | 2.7 | 3.0 | |
| (amine) | | | |
| Bis(3-triethoxysilylpropyl | 1.8 | | |
| (amine) | | | |
| y-aminopropyltri- | | | 2.8 |
| methoxysilane | | | |
| Oligomeric | | 2.0 | |
| vinyltriethoxysilane | | | |
| Xylene | 13.6 | 13.2 | 13.6 |
| Total part (ii) | 18.1 | 18.2 | 16.4 |
| Total part (i) and (ii) | 118.1 | 119.6 | 116.4 |
| % adhesion promoter | 9.0 | 6.0 | 5.5 |
| based on | | | |
| weight of | | | |
| silanol-terminated | | | |
| polydimethylsiloxane | | | |
| % adhesion promoter | 3.8 | 2.5 | 2.5 |
| based on | | | |
| total weight of | | | |
| tie-coat composition | | | |
| Curing time (hours | 1.5 | 1.5 | >24 hours |
| before tack free) | | | |
| Pot life (hours until | 2 | 2 | NA |
| the mixed tie- | | | |
| coat composition is | | | |
| too viscous to | | | |
| be spray applied) | | | |

One component systems

| | Tie-coat | Tie-coat |
|---|---|---|
| | compo- | compo- |
| | sition | sition |
| MODEL PAINTS | D | E |
| Silanol-terminated polydimethylsiloxane | 50.0 | 50.0 |
| (5,000 centipoise) | | |
| Xylene | 15.0 | 15.0 |
| Calcium carbonate | 17.9 | 17.9 |
| Titanium dioxide | 15.0 | 15.0 |
| Iron oxide | 3.0 | 3.0 |
| Bis(3-trimethoxysilylpropyl(amine) | 0.2 | |
| Bis(3-triethoxysilylpropyl(amine) | | 0.4 |
| vinyltris(methylethylketoximo)silane | 7.0 | 7.0 |
| Xylene | 7.7 | 7.7 |
| Total | 115.8 | 116.0 |
| % adhesion promoter based on weight of | 0.4 | 0.8 |
| silanol-terminated polydimethylsiloxane | | |
| % adhesion promoter based on total weight | 0.2 | 0.3 |
| of tie-coat composition | | |
| Curing time (hours before tack free) | 2 | 2 |
| Pot life (hours until the mixed tie-coat | 1.5 | 1.5 |
| composition is too viscous to be spray | | |
| applied) | | |

Other two component systems:

| | Tie- | Tie- |
|---|---|---|
| | coat | coat |
| | compo- | compo- |
| | sition | sition |
| MODEL PAINTS | F | G |
| Part (i) | | |
| Silanol-terminated polydimethylsiloxane | 50.0 | 50.0 |
| (5,000 centipoise) | | |
| Xylene | 15.0 | 15.0 |
| Calcium carbonate | 17.9 | 17.9 |
| Titanium dioxide | 15.0 | 15.0 |
| Iron oxide | 3.0 | 3.0 |
| Gamma glycidoxypropyl trimethoxysilane | 0.8 | |
| vinyltris(methylethylketoximo)silane | 7.0 | 7.0 |
| Bis(3-triethoxysilylpropyl(amine) | | 0.4 |
| Xylene | 7.7 | 7.7 |
| Total part (i) | 116.4 | 116 |
| Part (ii) | | |
| Gamma glycidoxypropyl trimethoxysilane | | 0.8 |
| Bis(3-triethoxysilylpropyl(amine) | 0.4 | |
| Xylene | 3.0 | 3.0 |
| Total part (ii) | 3.4 | 3.4 |
| Total part (i) and (ii) | 119.8 | 119.8 |
| % adhesion promoter based on weight of | 0.8 | 0.8 |
| silanol-terminated polydimethylsiloxane | | |
| % adhesion promoter based on total | 0.3 | 0.3 |
| weight of tie-coat composition | | |
| Curing time (hours before tack free) | 2 | 1 |
| Pot life (hours until the mixed tie-coat | 1.5 | 1 |
| composition is too viscous to be spray | | |
| applied) | | |

### Preparation of Test Panels

Year old epoxy coated steel panels (2×70×150 mm) are used as substrate for testing the adhesion of the above described tie-coat (the epoxy coat used is Hempadur 45750, from

Hempel A/S, applied in 75-100 μm dry film thickness). Prior to application of the tie-coat, the panels were cleansed with ethanol and sanded lightly. The panels were covered by the tie-coat, applied in 100-150 μm dry film thickness by a doctor blade hand applicator. After 24 hours of drying in the laboratory at the specified conditions, a foul release silicone topcoat (Hempasil 77100, from Hempel A/S) was applied in 150-200 pm dry film thickness by a doctor blade hand applicator. The panels were left to cure for additional 24 hours before testing was performed.

### The Adhesion Test

The adhesion of a coating formulation is tested by a peel test according to the following procedure. The tester attempts to remove the coating from the substrate/previous paint layer by scraping with a metal spatula.

The coating is considered to pass the test if there is only a cohesive failure in the layer to be tested and no adhesive failure between the layer and the substrate/previous layer.

The coating is considered to fail if there is an adhesive failure between any layer and another layer or between the layer and the substrate.

After the first evaluation of the adhesion, the test panels with the applied coatings were immersed in 40° C. hot freshwater and aged for 1 month before the adhesion was evaluated again.

As a supplement to this the adhesion was also tested after exposure in the blister box test.

### The Blister Box Test

The Blister Box Test was conducted according to ISO 6270-1. This method was performed in order to evaluate the water resistance of a coating system using controlled condensation.

The panel surface with the coating system were exposed to 40° C., saturated water vapour, at an angle of 15° to the horizontal. The reverse side of the panel was exposed to room temperature. After ending of the exposure (720 hours), adhesion was evaluated according to the above description.

### Results

| Model paint composition | Type of rupture before | Type of rupture after 1 |
|---|---|---|
| (tie-coat) | immersion | month immersed |
| A^{#} | cohesive | cohesive |
| B^{#} | cohesive | cohesive |
| C^{#} (*) | adhesive | adhesive |
| D^{§} | cohesive | cohesive |
| E^{§} | cohesive | cohesive |
| F^{§} | cohesive | cohesive |
| G^{§} | cohesive | cohesive |

^{#}Tested in accordance with the “Adhesion test”.
^{§}Tested in accordance with the “Blister Box test”.
(*) Tie-coat C did not cure at ambient conditions. After 24 hours the coating was still liquid. Only when the top-coat was applied, the catalyst from the top-coat facilitated curing of the tie-coat.

### Comment to Results:

The above results show that the tie-coats of the present invention facilitate adhesion of a fouling release system on aged epoxy. The adhesion promoter described in patent EP 1013347 B1 did not give sufficient adhesion, if used without a curing catalyst.

1. A condensation cure silicone RTV tie-coat composition comprising
(i) a silanol-terminated polydiorganosiloxane, and
(ii) 0.1-1.0% by wet weight of the total tie-coat'composition of one or more adhesion promoters selected from the group consisting of bis(trialkoxysilylalky)amines and N,N′-biS(trialkoxysilylalkyl)alkylenediamines.

2. The tie-coat composition according to claim 1, comprising (iii) up to 30% by wet weight of the total tie-coat composition of one or more silanes having two or more hydrolysable groups.

3. The tie-coat composition according to claim 2, which comprises 1-20% by wet weight of the total tie-coat composition of one or more-silanes having two or more hydrolysable groups.

4. The tie-coat composition according to any one of claims 1-3, wherein the one or more adhesion promoters are selected from bis(trialkoxysilylalkyl)amines having formula (1):
Si(OR³)₃R¹NHR²Si(OR⁴)₃ (I)
where R¹ and R² independently are C1-C5 alkylene groups and R³ and R⁴ independently are selected from methyl and ethyl; and
N,N′-bis(trialkoxysilylalkyl)alkylenediamines having formula (II):
Si(OR³)₃R¹NHR⁵NHR²Si(OR⁴)₃ (II)
where R¹, R² and R⁵ independently are C1-C5 alkylene groups and R³ and R⁴ independently are selected from methyl and ethyl.

5. The tie-coat according to claim 1, wherein the tie-coat composition comprises bis(3-trimethoxysilylpropyl)amine.

6. The tie-coat composition according to claim 1, wherein total amount of adhesion promoter is in the range of 1-5% by wet weight of the tie-coat composition.

7. The tie-coat composition according to claim 1, comprising in one part:
(i) a silanol-terminated polydiorganosiloxane,
(ii) 0.1-10% by wet weight of the total tie-icoat composition of one or more adhesion promoters selected from the group consisting of bis(trialkoxysilylalkyl)amines and N,N′-bis(trialkoxysilylalkyl)alkylenediamines; and
(iii) up to 30% by wet weight of the tie-coat composition of one or more silanes having two or more hydrolysable groups.

8. The tie-coat composition according to claim 1, comprising,
(i) a silanol-terminated polydiorganosiloxane in a first part, and
(ii) 0.1-10% by wet weight of the total tie-coat composition of one or more adhesion promoters selected from the group consisting of bis(trialkoxysilyialkyl)amines and N,N′-bis(trialkoxysilylalkyl)alkylenediamines in a second part.

9. The tie-coat composition according to claim 1, wherein the tie-coat composition, further comprises (iv) an epoxy silane in a part separate from the part comprising (ii) the one or more adhesion promoters.

10. A method of restoring a damaged foul release coating system area on a substrate, said method comprising the steps of: (a) applying to the damaged foul release coating area tie-coat composition as defined in claim 4, and (b) applying a fouling release top-coat onto the area treated instep (a).

11. A method of applying a foul release coating system to a freshly applied substrate of anticorrosive coat, said method comprising the steps of (a) applying to the anticorrosive substrate area a tie-coat composition as defined in claim 4, and (b) applying a fouling release top-coat onto the area treated in step (a).

12. A substrate comprising on at least a part of the surface thereof a tie-coat prepared by application of tie-coat composition as defined in claim 4.
